(19) United States
(12) Patent Application Publication
(10) Pub. No.: US 2022/0302432 A1
(43) Pub. Date: Sep. 22, 2022

(54) METHOD OF MANUFACTURING CATHODE ACTIVE MATERIAL FOR ALL-SOLID-STATE BATTERY

(71) Applicants: Hyundai Motor Company, Seoul (KR); Kia Corporation, Seoul (KR)

(72) Inventors: Sung Woo Noh, Seoul (KR); Sang Heon Lee, Yongin (KR); Je Sik Park, Seoul (KR); Jeong Hyun Seo, Daejeon (KR); Ju Yeong Seong, Suwon (KR); A Reum Ha, Ulsan (KR)

(21) Appl. No.: 17/525,440

(22) Filed: Nov. 12, 2021

(30) Foreign Application Priority Data
Mar. 18, 2021 (KR) 10-2021-0035331

(51) Int. Cl. H01M 4/131; H01M 4/36; H01M 4/1391; H01M 4/48

(52) U.S. Cl. CPC H01M 4/131; H01M 4/366; H01M 4/1391; H01M 4/48; H01M 2004/027

(57) ABSTRACT

Disclosed is a method of manufacturing a cathode active material for an all-solid-state battery by using sonication. The method includes: preparing a cathode active material; preparing a coating solution, the coating solution including a lithium-containing precursor and a transition-metal-containing precursor; preparing an admixture by adding the cathode active material to the coating solution; sonicating the admixture at a first temperature; and forming a coating layer including a lithium transition metal oxide on the cathode active material by heat-treating a resultant of the sonicating at a second temperature that is a temperature higher than the first temperature.

### CROSS REFERENCE TO RELATED APPLICATION

The present application claims priority to Korean Patent Application No. 10-2021-0035331, filed Mar. 18, 2021, the entire contents of which is incorporated herein for all purposes by this reference.

### TECHNICAL FIELD

The present invention relates to a method of manufacturing a cathode active material for an all-solid-state battery by using sonication.

### BACKGROUND

In recent years, secondary batteries have been widely used as high-performance energy sources for small-sized portable electronic devices, such as mobile phones, video cameras, and laptop computers, as well as large-capacity power storage batteries for vehicles and power storage systems.

In particular, a lithium secondary battery, which is one type of secondary battery, has advantages in that the lithium secondary battery has higher energy density, a larger capacity per unit area, a lower self-discharge rate, and a longer lifespan than a nickel-manganese battery or a nickel-cadmium battery. As a next-generation battery for electric vehicles, however, the lithium secondary battery has various problems such as a stability problem due to overheating and low output.

In particular, the lithium secondary battery uses a combustible organic solvent as an electrolyte solvent. When a short circuit occurs in the lithium secondary battery due to physical damage to the lithium secondary battery, the lithium secondary battery may easily explode or catch fire. In recent years, therefore, an all-solid-state battery that uses a solid electrolyte as an electrolyte in order to improve the safety thereof has attracted considerable attention.

The solid electrolyte may be divided into a sulfide-based solid electrolyte and an oxide-based electrolyte, and the sulfide-based solid electrolyte having high lithium-ion conductivity is mainly used.

In the all-solid-state battery, the solid electrolyte is added to an electrode for a movement of lithium ions in the electrode. However, there is a problem in that a side reaction occurs between the sulfide-based solid electrolyte and a cathode active material. In order to prevent the problem, a coating layer was formed on a surface of the cathode active material to suppress the side reaction between the cathode active material and the sulfide-based solid electrolyte.

### SUMMARY

In preferred aspects, provided is a method of manufacturing a cathode active material that is capable of reducing a resistance in an electrode and capable of improving a performance of a battery.

In one aspect, methods are provided for manufacturing a cathode active material for an all-solid-state battery, comprising: (a) admixing a cathode active material and a coating composition comprising a lithium-containing precursor and a transition-metal-containing precursor to provide an admixture; and (b) sonicating the admixture.

Suitably, the method may further comprises heating the admixture, such as where the admixture is heat-treated after sonicating. Suitably, in such embodiments, the admixture is sonicated at a first temperature and following sonicating the admixture is heat-treated at a second temperature higher than the first temperature.

In a further aspect, provided is a method of manufacturing a cathode active material for an all-solid-state battery. The method may include preparing a cathode active material; preparing a coating solution, the coating solution including a lithium-containing precursor and a transition-metal-containing precursor; preparing an admixture by adding the cathode active material to the coating solution; sonicating the admixture at a first temperature; and heat-treating a resultant of the sonicating.

The cathode active material may include an oxide-based cathode active material.

The cathode active material may include LiNi_{1-x-y}CoₓMn_{y}Al_{z}O₂ (in which x, y, and z are numbers in following ranges: 0<x, 0<y, 0<z and 0<x+y+z≤0.4).

The lithium-containing precursor may suitably include lithium ethoxide.

The transition-metal-containing precursor may suitably include one or more selected from the group consisting of niobium ethoxide, vanadium ethoxide, and zirconium ethoxide.

By the sonicating, energy in an amount such that a metal does not precipitate from the lithium-containing precursor and from the transition-metal-containing precursor may be transferred to the admixture.

The first temperature may be about 50° C. to 70° C.

A resultant in a powder state may be obtained by removing a solvent in the admixture by the sonicating.

The resultant of the sonicating may be heat-treated in an oxygen atmosphere.

The heat-treating may be performed at a temperature of about 300° C. to 350° C.

The resultant performed by the heat-treating may suitably include: a core layer including a cathode active material; and a coating layer coated on all or part of a surface of the core layer, wherein the coating layer may include one or more selected from the group consisting of LiNbO₃, LiNb₃O₈, Li₃NbO₄, LiNbO₂, Li₈Nb₂O₉, LiV₃O₈, LiVO₂, LiVO₄, Li₃VO₄, LiVO₃, LiV₂O₅, LiV₂O₄, Li₂V₁₈O₃₉, LiV₆O₁₃, Li₂V₆O₁₃, Li₂ZrO₃, and Li₆Zr₂O₇.

In an aspect, provided is a method of manufacturing a cathode for an all-solid-state battery. The method may include: preparing a starting material, the starting material including the cathode active material manufactured by the above-described method and a solid electrolyte; and manufacturing a cathode by using the starting material.

The solid electrolyte may include a sulfide-based solid electrolyte.

The cathode may have a lithium-ion conductivity of about 4.0×10⁻⁴ S/cm to 6.0×10⁻⁴ S/cm.

According to various exemplary embodiments of the present invention, the coating layer may be uniformly formed on the surface of the cathode active material, thereby reducing a resistance in an electrode and improving performance of a battery.

In further aspects, a cathode is provided as may be obtainable or obtained from a method as disclosed herein.

In a yet further aspect, a battery is provided, including an all-solid-state battery, that comprises a cathode as disclosed herein, including a cathode is provided obtainable or obtained from a method as disclosed herein.

In a still further aspect, vehicles are provided that include a battery as disclosed herein.

Other aspects of invention are disclosed infra.

### BRIEF DESCRIPTION OF THE DRAWINGS

The above and other objectives, features, and other advantages of the present invention will be more clearly understood from the following detailed description when taken in conjunction with the accompanying drawings, in which:

FIG. 1 shows an exemplary all-solid-state battery according to an exemplary embodiment of the present invention;

FIG. 2 shows an exemplary cathode active material coated with a coating layer, according to an exemplary embodiment of the present invention;

FIG. 3 shows an exemplary sonication device according to an exemplary embodiment of the present invention;

FIG. 4A is a graph showing a result of analyzing a cathode prepared with a cathode active material in Example 1 according to an exemplary embodiment of the present invention by using impedance spectroscopy;

FIG. 4B is a graph showing a result of analyzing a cathode prepared with a cathode active material in Example 2 according to an exemplary embodiment of the present invention by using impedance spectroscopy;

FIG. 4C is a graph showing a result of analyzing a cathode prepared with a cathode active material according to Comparative Example 1 by using impedance spectroscopy; and

FIG. 4D is a graph showing a result of analyzing a cathode prepared with a cathode active material according to Comparative Example 2 by using impedance spectroscopy.

### DETAILED DESCRIPTION

The objectives, features, and advantages of the present invention will be easily understood through the following detailed description of specific exemplary embodiments and the attached drawings. However, the present invention is not limited to the exemplary embodiments and may be embodied in other forms. On the contrary, the exemplary embodiments are provided so that the invention of the present invention may be completely and fully understood by those of ordinary skill.

In the attached drawings, like numerals are used to represent like elements. In the drawings, the dimensions of the elements are enlarged for easier understanding of the present invention. Although the terms first, second, etc. may be used to describe various elements, these elements should not be limited by the terms. The terms are used only to distinguish one element from another. For example, a first element can be termed a second element and, similarly, a second element can be termed a first element without departing from the scope of the present invention. A singular expression includes a plural expression unless the context clearly indicates otherwise.

As referred to herein, the term “sonication” includes for examples where a sound waves are applied to a material, such as where sound waves from a transducer to a vessel via a sonotrode coupled between the transducer and the vessel. In certain aspects, any sonication frequency, amplitude and time may be employed. In certain aspects, the frequency may be at least 1 kHz, but more typically at least 20 kHz. In the present invention, terms such as “include”, “contain”, “have”, etc. should be understood as designating that features, numbers, steps, operations, elements, parts or combinations thereof exist and not as precluding the existence of or the possibility of adding one or more other features, numbers, steps, operations, elements, parts or combinations thereof in advance. In addition, when an element such as a layer, a film, a region, a substrate, etc. is referred to as being “on” another element, it can be “directly on” the another element or an intervening element may also be present. Likewise, when an element such as a layer, a film, a region, a substrate, etc. is referred to as being “under” another element, it can be “directly under” the another element or an intervening element may also be present.

Unless specified otherwise, all the numbers, values and/or expressions representing the amount of components, reaction conditions, polymer compositions or mixtures are approximations reflecting various uncertainties of measurement occurring in obtaining those values and should be understood to be modified by “about”. Further, unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Also, unless specified otherwise, all the numerical ranges disclosed in the present invention are continuous and include all the values from the minimum values to the maximum values included in the ranges. In addition, when the ranges indicate integers, all the integers from the minimum values to the maximum values included in the ranges are included unless specified otherwise. For example, the range of “5 to 10” will be understood to include any subranges, such as 6 to 10, 7 to 10, 6 to 9, 7 to 9, and the like, as well as individual values of 5, 6, 7, 8, 9 and 10, and will also be understood to include any value between valid integers within the stated range, such as 5.5, 6.5, 7.5, 5.5 to 8.5, 6.5 to 9, and the like. Also, for example, the range of “10% to 30%” will be understood to include subranges, such as 10% to 15%, 12% to 18%, 20% to 30%, etc., as well as all integers including values of 10%, 11%, 12%, 13% and the like up to 30%, and will also be understood to include any value between valid integers within the stated range, such as 10.5%, 15.5%, 25.5%, and the like.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

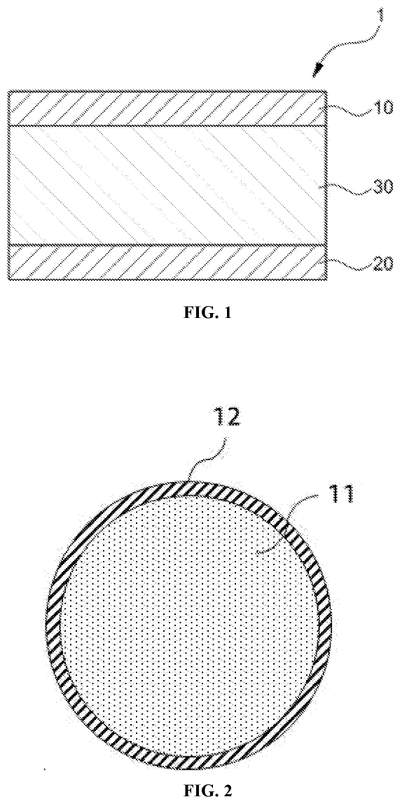

FIG. 1 is a cross-sectional view illustrating an all-solid-state battery 1 according to an exemplary embodiment of the present invention. The all-solid-state battery 1 may include a cathode 10, an anode 20, and a solid electrolyte layer 30 positioned between the cathode 10 and the anode 20.

Cathode

The cathode 10 may include a cathode active material, a solid electrolyte, a conductive material, a binder, and the like.

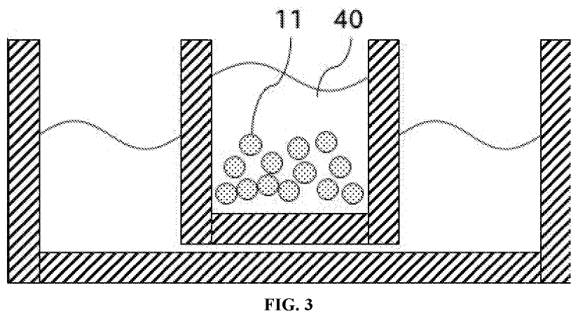

FIG. 2 is a view illustrating a cathode active material 11 coated with a coating layer 12 according to an exemplary embodiment of the present invention. The cathode active material 11 may form a core layer, and the coating layer 12 may be coated on all or part of a surface of the core layer.

The cathode active material 11 may include an oxide-based cathode active material. For example, the cathode active material 11 may include a rock-salt-layer-type active material such as LiCoO₂, LiMnO₂, LiNiO₂, LiVO₂, LiNi_{1-x-y}CoₓMn_{y}Al_{z}O₂ (in which x, y, and z are numbers in following ranges: 0<x, 0<y, 0<z, and 0<x+y+z≤0.4), and the like; a spinel-type active material such as LiMn₂O₄, Li(Ni_{0.5}Mn_{1.5})O₄, and the like; an inverse-spinel-type active material such as LiNiVO₄, LiCoVO₄, and the like; an olivine-type active material such as LiFePO₄, LiMnPO₄, LiCoPO₄, LiNiPO₄, and the like; a silicon-containing active material such as Li₂FeSiO₄, Li₂MnSiO₄, and the like; a rock-solid-layer-type active material in which a portion of a transition metal is substituted with a different metal, such as LiNi_{0.8}Co_{(0.2-x)}AlₓO₂ (0<x<0.2); a spinel-type active material in which a portion of a transition metal is substituted with a different metal, such as Li₁₊ₓMn_{2-x-y}M_{y}O₄ (M being at least one of Al, Mg, Co, Fe, Ni, and Zn, 0<x+y<2); or lithium titanate such as Li₄Ti₅O₁₂ and the like.

Preferably, the cathode active material 11 may include LiNi_{1-x-y}CoₓMn_{y}Al_{z}O₂ (in which x, y, and z are numbers in following ranges: 0<x, 0<y, 0<z, and 0<x+y+z≤0.4).

The coating layer 12 is an element that prevents the cathode active material 11 from being in contact with the solid electrolyte by being coated on the cathode active material 11.

The coating layer 12 may include a lithium transition metal oxide. For example, the coating layer 12 may include one or more selected from the group consisting of LiNbO₃, LiV₃O₈, and Li₂ZrO₃.

The present invention relates to a method of manufacturing a cathode active material on which the coating layer 12 is capable of being uniformly formed. The method may include: preparing a cathode active material (S1); preparing a coating solution, the coating solution including a lithium-containing precursor and a transition-metal-containing precursor (S2); preparing an admixture by adding the cathode active material to the coating solution (S3); sonicating the admixture at a first temperature (S4); and forming a coating layer, in which a lithium transition metal oxide is included, on the cathode active material by heat-treating a resultant of the sonicating at a second temperature that is a temperature higher than the first temperature (S5).

The preparing of a cathode active material (S1) may be a process that is preparing the cathode active material in a powder state.

The preparing of a coating solution (S2) may be a process that is dissolving the lithium-containing precursor and the transition-metal-containing precursor that are precursors of the coating layer in an organic solvent such as anhydrous ethanol.

The lithium-containing precursor may include lithium ethoxide.

The transition-metal-containing precursor may include one or more selected from the group consisting of niobium ethoxide, vanadium ethoxide, and zirconium ethoxide.

The admixture may be obtained by adding the cathode active material to the coating solution (S3).

In the admixture, a content of the cathode active material, the lithium-containing precursor, and the transition-metal-containing precursor is not particularly limited, and may be appropriately adjusted depending on a type and a thickness of the coating layer 12. For example, the admixture may include the lithium-containing precursor in an amount of about 0.3 wt % to 2 wt %, based on 100 wt % of the cathode active material. In addition, the admixture may include the transition-metal-containing precursor in an amount of about 0.2 wt % to 2 wt %, based on 100 wt % of the cathode active material. When two components among niobium ethoxide, vanadium ethoxide, and zirconium ethoxide are used as the transition-metal-containing precursor, the two components may be mixed at a weight ratio of 1:9 or 9:1.

According to an exemplary embodiment of the present invention, a coating layer in a gel-state derived from the coating solution 40 is formed on a surface of the cathode active material 11 by sonicating the admixture at a predetermined temperature.

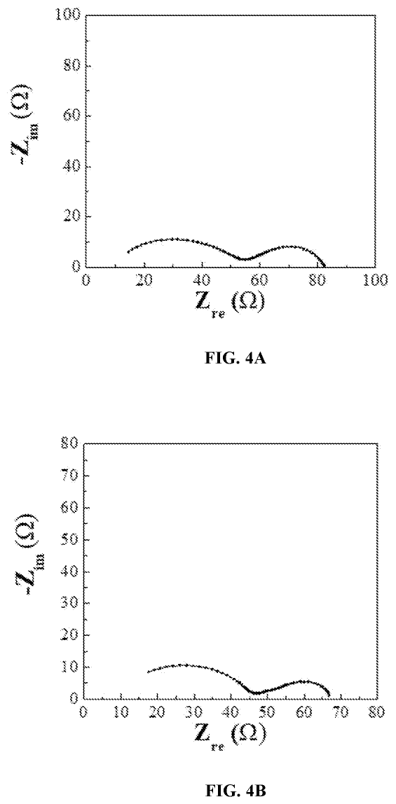

FIG. 3 shoes an exemplary sonication device according to an exemplary embodiment of the present invention. The sonicating may be a process that is transferring energy to the admixture contained in a container with a predetermined shape via a medium by generating a sonic wave through a probe (not illustrated) and the like after the admixture is placed in a sonication bath in which the medium is accommodated, in which the cathode active material 11 and a coating solution 40 are included in the admixture.

According to the present invention, the coating layer in the gel-state may be uniformly coated on the cathode active material by vibrating the cathode active material by the sonicating. However, it may be preferable to perform the sonication with a mild condition so that a metal does not precipitate from the lithium-containing precursor and from the transition-metal-containing precursor by energy transferred to the admixture by sonicating. When the metal is precipitated, it may be difficult for the coating solution from being derived to the gel-state coating layer, and the surface of the cathode active material may not be uniformly coated. Specifically, the sonication may be performed in the first temperature condition of 50° C. to 70° C. The first temperature condition may be adjusted by the intensity of the sonic wave, etc. In addition, the sonication may be performed until the solvent in the admixture is removed and a resultant in a power state is obtained. The “resultant in a powder state” does not mean that liquid components such as water are completely removed, and that does mean a resultant that 70% or more, 80% or more, 90% or more, or 95% or more of the solvent in the admixture is removed.

After that, the coating layer in which a lithium transition metal oxide is included may be formed on the cathode active material by heat-treating the resultant of the sonicating (S5).

The lithium transition metal oxide may be obtained by oxidizing through heat-treatment the coating layer in the gel-state derived from the lithium-containing precursor and the transition-metal-containing precursor in an oxygen atmosphere.

The heat-treatment may be performed in a second temperature condition of about 300° C. to 350° C. The heat-treatment time is not particularly limited and performed for a time that the coating layer and the cathode active material are not damaged. For example, the time may be about 1 to 24 hours, about 1 to 12 hours, about 1 to 6 hours, or about 1 to 3 hours.

The solid electrolyte may suitably include an oxide-based solid electrolyte or a sulfide-based solid electrolyte. However, it is preferable to use the sulfide-based solid electrolyte with high lithium-ion conductivity.

The sulfide-based solid electrolyte may suitably include Li₂S—P₂S₅, Li₂S—P₂S₅—LiCl, Li₂S—P₂S₅—LiBr, Li₂S—P₂S₅—Li₂O, Li₂S—SiS₂, Li₂S—SiS₂—LiBr, Li₂S—SiS₂—LiCl, Li₂S—B₂S₃, Li₂S—P₂S₅—ZmSn (in which m and n are positive numbers, and Z is any one of Ge, Zn, and Ga), Li₂S—GeS₂, Li₂S—SiS₂—Li₃PO₄, Li₂S—SiS₂—LiₓMO_{y} (in which x and y are positive numbers, and M is any one of P, Si, Ge, B, Al, Ga, and In), Li₁₀GeP₂Si₂, Li_{3-2X}M_{X}In_{1-Y}M′_{Y}L_{6-Z}L′_{Z} (in which M and M′ are metallic element, and L and L′ are halogen element). In addition, X, Y, and Z may independently satisfy 0≤X<1.5, 0≤Y<1, and 0≤Z≤6.

Preferably, the solid electrolyte may suitably include Li_{3-2X}M_{X}In_{1-Y}M′_{Y}L_{6-Z}L′_{Z} (in which M and M′ are metallic element, and L and L′ are halogen element). In addition, X, Y, and Z may independently satisfy 0≤X<1.5, 0≤Y<1, and 0≤Z≤6.

The conductive material may include an element that forms an electronic conduction path in the cathode 10. The conductive material may be a sp² carbon material, such as carbon black, conducting graphite, ethylene black, or carbon nanotube, or graphene.

The binder may suitably include butadiene rubber (BR), nitrile butadiene rubber (NBR), hydrogenated nitrile butadiene rubber (HNBR), polyvinylidene difluoride (PVDF), polytetrafluoroethylene (PTFE), carboxymethyl cellulose (CMC), or the like.

The method of manufacturing the cathode according to an exemplary embodiment of the present invention may include: preparing a starting material, the starting material including the cathode active material, a solid electrolyte, and so on; and manufacturing the cathode by using the starting material.

The starting material may be a slurry obtained by adding the cathode active material, the solid electrolyte, the binder, the conductive material, and so on to a solvent. A cathode may be manufactured by applying and drying the slurry on a substrate.

On the other hand, the starting material may be a powder including the cathode active material, the solid electrolyte, the conductive material, and so on. A cathode may be manufactured by adding the powder to a mold having a predetermined shape and applying a predetermined pressure.

Anode

The anode 20 may include an anode active material, a solid electrolyte, a binder, and the like.

The anode active material is not particularly limited. For example, the anode active material may be a carbon active material or a metal active material.

The carbon active material may suitably include mesocarbon microbeads (MCMB), graphite such as highly ordered pyrolytic graphite (HOPG), or amorphous carbon such as hard carbon or soft carbon.

The metal active material may suitably include In, Al, Si, Sn, or an alloy including at least one thereof.

The solid electrolyte may suitably include an oxide-based solid electrolyte or a sulfide-based solid electrolyte. However, it is preferable to use the sulfide-based solid electrolyte with high lithium-ion conductivity.

The sulfide-based solid electrolyte suitably include Li₂S—P₂S₅, Li₂S—P₂S₅—LiI, Li₂S—P₂S₅—LiCl, Li₂S—P₂S₅—LiBr, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (in which m and n are positive numbers, and Z is any one of Ge, Zn, and Ga), Li₂S—GeS₂, Li₂S—SiS₂—Li₃PO₄, Li₂S—SiS₂—LiₓMO_{y} (in which x and y are positive numbers, and M is any one of P, Si, Ge, B, Al, Ga, and In), Li₁₀GeP₂S₁₂, or Li_{3-2X}M_{X}In_{1-Y}M′_{Y}L_{6-Z}L′_{Z} (in which M and M′ are metallic element, and L and L′ are halogen element). In addition, X, Y, and Z may independently satisfy 0≤X<1.5, 0≤Y<1, and 0≤Z≤6.

Preferably, the solid electrolyte may suitably include Li_{3-2X}M_{X}In_{1-Y}M′_{Y}L_{6-Z}L′_{Z} (in which M and M′ are metallic element, and L and L′ are halogen element). In addition, X, Y, and Z may independently satisfy 0≤X<1.5, 0≤Y<1, and 0≤Z≤6.

The solid electrolyte included in the anode 20 may or may not be equal to the solid electrolyte included in the cathode 10.

The binder may suitably include butadiene rubber (BR), nitrile butadiene rubber (NBR), hydrogenated nitrile butadiene rubber (HNBR), polyvinylidene difluoride (PVDF), polytetrafluoroethylene (PTFE), carboxymethyl cellulose (CMC), or the like.

The binder included in the anode 20 may or may not be equal to the binder included in the cathode 10.

In addition, the anode 20 may not include the anode active material. In particular, an all-solid-state battery according to the present invention may be an anodeless-type all-solid-state battery that an anode active material is removed and lithium is directly precipitated to an anode current collector. At this time, the anode 20 may include a carbon material and a metal alloyable with lithium.

The carbon material may be an amorphous carbon material that is not functioning as an anode active material.

The metal alloyable with lithium may suitably include one or more selected from the group consisting of gold (Au), platinum (Pt), palladium (Pd), silicon (Si), silver (Ag), aluminum (Al), bismuth (Bi), tin (Sn), and zinc (Zn).

Solid Electrolyte Layer

The solid electrolyte layer 30 is positioned between the cathode 10 and the anode 20, and is configured to allow lithium ions to move between the cathode 10 and the anode 20.

The solid electrolyte layer 30 may suitably include a solid electrolyte and a binder.

The solid electrolyte may suitably include an oxide-based solid electrolyte or a sulfide-based solid electrolyte. However it is preferable to use the sulfide-based solid electrolyte with high lithium-ion conductivity.

The sulfide-based solid electrolyte suitably include Li₂S—P₂S₅, Li₂S—P₂S₅—LiCl, Li₂S—P₂S₅—LiBr, Li₂S—P₂S₅—Li₂O, Li₂S—SiS₂, Li₂S—SiS₂—LiBr, Li₂S—SiS₂—LiCl, Li₂S—SiS₂—B₂S₃—LiI, Li₂S—B₂S₃, Li₂S—P₂S₅—ZmSn (in which m and n are positive numbers, and Z is any one of Ge, Zn, and Ga), Li₂S—GeS₂, Li₂S—SiS₂—Li₃PO₄, Li₂S—SiS₂—LiₓMO_{y} (in which x and y are positive numbers, and M is any one of P, Si, Ge, B, Al, Ga, and In), Li₁₀GeP₂S₁₂, Li_{3-2X}M_{X}In_{1-Y}M′_{Y}L_{6-Z}L′_{Z} (in which M and M′ are metallic element, and L and L′ are halogen element). In addition, X, Y, and Z may independently satisfy 0≤X<1.5, 0≤Y<1, and 0≤Z≤6.

Preferably, the solid electrolyte may suitably include Li_{3-2X}M_{X}In_{1-Y}M′_{Y}L_{6-Z}L′_{Z} (in which M and M′ are metallic element, and L and L′ are halogen element). In addition, X, Y, and Z may independently satisfy 0≤X<1.5, 0≤Y<1, and 0≤Z≤6.

The solid electrolyte included in the solid electrolyte layer 30 may or may not be equal to the solid electrolyte included in the cathode 10 or the anode 20.

The binder may suitably include butadiene rubber (BR), nitrile butadiene rubber (NBR), hydrogenated nitrile butadiene rubber (HNBR), polyvinylidene difluoride (PVDF), polytetrafluoroethylene (PTFE), carboxymethyl cellulose (CMC), or the like.

The binder included in the solid electrolyte layer 30 may or may not be equal to the binder included in the cathode 10 or the anode 20.

### EXAMPLE

Hereinafter, the present invention will be described more specifically through examples. However, these examples are provided only for the understanding of the present invention, and the scope of the present invention is not limited to these examples in any sense.

### Example 1

LiNi_{0.8}Co_{0.1}Mn_{0.1}O₂ as a cathode active material was prepared (S1).

A coating solution was prepared by dissolving a lithium ethoxide in an amount of 0.3 wt %, a niobium ethoxide in an amount of 1.8 wt %, and a vanadium ethoxide in an amount of 0.2 wt % to ethanol, based on 100 wt % of a cathode active material.

An admixture was obtained by adding the cathode active material to the coating solution (S₃).

The admixture was sonicated by using a device as illustrated in FIG. 3. The sonication was performed at a temperature of about 60° C., and a resultant in a powder state in which a solvent is removed at a predetermined level was obtained.

The resultant of the sonicating was heat-treated at a temperature of 370° C. for three hours in an oxygen atmosphere, and a cathode active material on which a coating layer is coated was obtained.

### Example 2

The same procedure as in the Example 1 was performed to manufacture a cathode active material, except that LiNi_{0.7}Co_{0.15}Mn_{0.15}O₂ as a cathode active material was used.

### Comparative Example 1

The same procedure as in the Example 1 was performed to manufacture a cathode active material, except that a solvent in an admixture was removed by only applying a heat without sonicating.

### Comparative Example 2

The same procedure as in the Comparative Example 1 was performed to manufacture a cathode active material, except that LiNi_{0.7}Co_{0.15}Mn_{0.15}O₂ as a cathode active material was used.

### Experimental Example 1

Each of the Example 1, the Example 2, the Comparative Example 1, and the Comparative Example 2, was respectively mixed with a solid electrolyte at a weight ratio of 8:2. 0.3 g of a mixture was placed in a mold with a diameter of 13 mm and uniaxially pressed at a pressure of about 500 MPa, and a cathode in a pellet form was manufactured.

After connecting SUS electrodes to both sides of the cathode, electrochemical properties of the cathode were evaluated by impedance spectroscopy at a frequency range of from 1 MHz to 0.01 Hz.

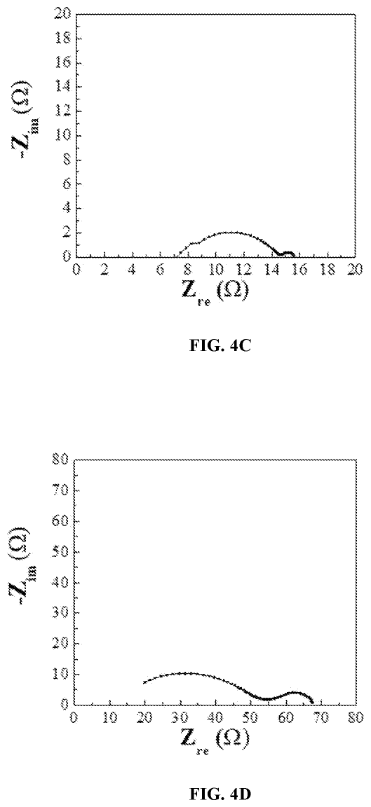

FIGS. 4A to 4D are graphs each showing a result of analyzing a cathode prepared with a cathode active material according to the Example 1, the Example 2, the Comparative Example 1, and the Comparative Example 2, respectively, by impedance spectroscopy. Based on these results, ion conductivity of each sample was calculated. The calculated ion conductivities are represented by following Table 1.

TABLE 1

| Items | Ion conductivity [S/cm] |
|---|---|
| Example 1 | 4.5 × 10⁻⁴ |
| Comparative Example 1 | 3.2 × 10⁻⁴ |
| Example 2 | 4.8 × 10⁻⁴ |
| Comparative Example 2 | 2.9 × 10⁻⁴ |

Since a thickness of a sample according to the Example 1, the Example 2, the Comparative Example 1, and the Comparative Example 2 were the same, high ion conductivity of a sample can be interpreted as low ion resistance. Here, the ion conductivity refers to a lithium-ion conductivity.

As shown in Table 1, each ion conductivity of the cathode prepared with the cathode active material in Example 1 and the Example 2 was equal to or greater than 4.0×10⁻⁴ S/cm, indicating that each of Example 1 and the Example 2 had higher ion conductivity compared to the ion conductivity of the Comparative Example 1 and the Comparative Example 2. This means that the ion resistance of each the Example 1 and the Example 2 was lower than that of each the Comparative Example 1 and the Comparative Example 2.

As a result, according to various exemplary embodiments of the present invention, a coating layer may be formed more uniformly on a cathode active material, thereby improving a performance of a battery.

As described above, while the present invention has been specifically described, the scope of the present invention is not limited to the above-disclosed experimental example and exemplary embodiments, and various modifications and improvements of those skilled in the art using the basic concept of the present invention, which is defined in the appended claims, are also included in the scope of the present invention.

What is claimed is:

1. A method of manufacturing a cathode active material for an all-solid-state battery, comprising:
admixing a cathode active material and a coating composition comprising a lithium-containing precursor and a transition-metal-containing precursor to provide an admixture;
sonicating the admixture.

2. The method of claim 1 further comprising heating the admixture.

3. The method of claim 2 wherein the admixture is heat-treated after sonicating.

4. The method of claim 2 wherein the admixture is sonicated at a first temperature and following sonicating the admixture is heat-treated at a second temperature higher than the first temperature.

5. The method of claim 1 comprising: preparing a cathode active material;
preparing a coating solution comprising a lithium-containing precursor and a transition-metal-containing precursor;
preparing an admixture a cathode active material to the coating solution;
sonicating the admixture at a first temperature; and
heat-treating a resultant of the sonicating.

6. The method of claim 1, wherein the cathode active material comprises an oxide-based cathode active material.

7. The method of claim 1, wherein the cathode active material comprises LiNi_{1-x-y}CoₓMn_{y}Al_{z}O₂ (in which x, y, and z are numbers in following ranges: 0<x, 0<y, 0<z, and 0<x+y+z≤0.4).

8. The method of claim 1, wherein the lithium-containing precursor comprises lithium ethoxide.

9. The method of claim 1, wherein the transition-metal-containing precursor comprises one or more selected from the group consisting of niobium ethoxide, vanadium ethoxide, and zirconium ethoxide.

10. The method of claim 1, wherein energy in an amount such that a metal does not precipitate from the lithium-containing precursor and from the transition-metal-containing precursor is transferred to the admixture by the sonicating.

11. The method of claim 1, wherein the first temperature is about 50° C. to 70° C.

12. The method of claim 1, wherein a powder state resultant is obtained by removing a solvent in the admixture following sonicating.

13. The method of claim 5, wherein the resultant of the sonicating is heat-treated in an oxygen atmosphere.

14. The method of claim 3, wherein the heat-treating is performed at a temperature of about 300° C. to 350° C.

15. The method of claim 2, wherein the reaction product provided following heating comprises:
a core layer comprising a cathode active material; and
a coating layer coated on all or part of a surface of the core layer,
wherein the coating layer comprises one or more selected from the group consisting of LiNbO₃, LiNb₃O₈, Li₃NbO₄, LiNbO₂, Li₈Nb₂O₉, LiV₃O₈, LiVO₂, LiVO₄, Li₃VO₄, LiVO₃, LiV₂O₅, LiV₂O₄, Li₂V₁₈O₃₉, LiV₆O₁₃, Li₂V₆O₁₃, Li₂ZrO₃, and Li₆Zr₂O₇.

16. A method of manufacturing a cathode for an all-solid-state battery, comprising:
preparing a starting material, the starting material comprising the cathode active material of claim 1 and a solid electrolyte; and
manufacturing a cathode by using the starting material.

17. The method of claim 16, wherein the solid electrolyte comprises a sulfide-based solid electrolyte.

18. The method of claim 16, wherein the cathode has a lithium-ion conductivity of about 4.0×10⁻⁴ S/cm to 6.0×10⁻⁴ S/cm.

19. A cathode prepared by a method of claim 16.

20. A battery comprising the cathode of claim 19.
